(19) United States
(12) Patent Application Publication
(10) Pub. No.: US 2024/0336011 A1
(43) Pub. Date: Oct. 10, 2024

(54) SYSTEM AND METHOD FOR 3D PRINTING A NON-PLANAR SURFACE

(71) Applicant: PPG Industries Ohio, Inc., Cleveland, OH (US)

(72) Inventors: Kerianne Merceline Dobosz, Pittsburgh, PA (US); Eric Scott Epstein, Pasadena, CA (US); Bryan William Wilkinson, Pittsburgh, PA (US); Michael Anthony Bubas, Pittsburgh, PA (US); Cynthia Kutchko, Pittsburgh, PA (US); Minh Anh Tong, Allison Park, PA (US); Leslie Owen Archuleta, Sarasota, FL (US)

(73) Assignee: PPG Industries Ohio, Inc., Cleveland, OH (US)

(21) Appl. No.: 18/294,600

(22) PCT Filed: Aug. 4, 2022
(86) PCT No.: PCT/US2022/074499

§ 371 Date: Feb. 2, 2024

Related U.S. Application Data
(60) Provisional application No. 63/269,547, filed on Mar. 18, 2022.
(60) Provisional application No. 63/230,577, filed on Aug. 6, 2021.

(51) Int. Cl. B29C 64/393; B29C 64/118; B29C 64/336; B29C 64/343; B29K 101/10; B33Y 50/02

(52) U.S. Cl. CPC B29C 64/393; B29C 64/118; B29C 64/336; B29C 64/343; B29K 2101/10; B33Y 50/02

(57) ABSTRACT

A computer system for dynamically controlling a three-dimensional printer may comprise one or more processors and one or more computer-readable media having stored thereon executable instructions that, when executed by the one or more processors, configure the computer system to perform various acts. The computer system may receive an indication to cause a three-dimensional printer to print a non-planar surface. Additionally, the computer system may calculate multiple different bead sizes for creating the non-planar surface using components of the three-dimensional printer. The computer system may also create a command to generate the multiple different bead sizes at locations within a printing area.

### CROSS-REFERENCE TO RELATED APPLICATIONS

This application claims priority to and the benefit of U.S. Provisional Application Ser. No. 63/269,547, filed on Mar. 18, 2022, entitled “SYSTEM AND METHOD FOR 3D PRINTING A NON-PLANAR SURFACE”, and also claims priority to and the benefit of U.S. Provisional Application Ser. No. 63/230,577, filed on Aug. 6, 2021, entitled “SYSTEM AND METHOD FOR 3D PRINTING A NON-PLANAR SURFACE.” All of the aforementioned applications are incorporated by reference herein in their entirety.

### BACKGROUND OF THE INVENTION

### 1. Technical Field

The present invention relates to computer control of three-dimensional printing methods that use coreactive materials.

### 2. Background and Relevant Art

Three-dimensional (3D) printing, also referred to as additive manufacturing, has experienced a technological explosion in the last several years. This increased interest is related to the ability of 3D printing to easily manufacture a wide variety of objects from common computer-aided design (CAD) files. In 3D printing, a composition is laid down in successive layers of material to build a structure. These layers may be produced, for example, from liquid, powder, paper, or sheet material.

In conventional configurations, a 3D printing system utilizes a thermoplastic material. The 3D printing system extrudes the thermoplastic material through a heated nozzle on to a platform. Using instructions derived from a CAD file, the system moves the nozzle with respect to the platform, successively building up layers of thermoplastic material to form a 3D object. After being extruded from the nozzle, the thermoplastic material cools. The resulting 3D object is thus made of layers of thermoplastic material that have been extruded in a heated form and layered on top of each other.

There are many ways in which 3D printing can be improved. These improvements may comprise faster printing, higher resolution printing, more durable end products, among many other desired outcomes.

### BRIEF SUMMARY OF THE INVENTION

A computer system for dynamically controlling a three-dimensional printer may comprise one or more processors and one or more computer-readable media having stored thereon executable instructions that, when executed by the one or more processors, configure the computer system to perform various acts. The computer system may receive an indication to cause a thermoset three-dimensional printer to print a non-planar surface. Additionally, the computer system may calculate multiple different bead sizes for creating the non-planar surface using thermoset components. The computer system may also create a command to generate the multiple different bead sizes ratios at locations within a printing area.

Additionally, a computer-implemented method for dynamically controlling a three-dimensional printer may be executed on one more processor. The computer-implemented method may comprise receiving an indication to cause a thermoset three-dimensional printer to print a non-planar surface. Additionally, the computer-implemented method may comprise calculating multiple different bead sizes for creating the non-planar surface using thermoset components. The computer-implemented method may also comprise creating a command to generate the multiple different bead sizes at specific locations within a printing area.

Further, a computer-readable media may comprise one or more physical computer-readable storage media having stored thereon computer-executable instructions that, when executed at a processor, cause a computer system to perform a method for dynamically controlling a three-dimensional printer. The executed method may comprise receiving an indication to cause a thermoset three-dimensional printer to print a non-planar surface. Additionally, the executed method may comprise calculating multiple different bead sizes for creating the non-planar surface using thermoset components. The executed method may also comprise creating a command to generate the multiple different bead sizes at specific locations within a printing area.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a system for thermoset 3D printing.

FIG. 2 illustrates a schematic of a computer system for thermoset 3D printing.

FIG. 3 illustrates a side view of different bead sizes.

FIG. 4 illustrates varying bead sizes along a tool path.

FIG. 5 illustrates varying bead sizes along multiple tool paths.

FIG. 6A illustrates a side view of different bead sizes along a non-planar surface.

FIG. 6B illustrates another side view of different bead sizes along a non-planar surface.

FIG. 6C illustrates another side view of different bead sizes along a non-planar surface.

FIG. 7 illustrates a flowchart of steps for dynamically controlling a thermoset three-dimensional (3D) printer.

FIG. 8 illustrates an example of dimensions of a desired non-planar surface.

FIG. 9 illustrates an example tool path along a slope (i.e., a tapered surface).

FIG. 10 illustrates different extrusion rates in the travel down and travel up of the slop shown in FIG. 9 to compensate for the lag of the extrusion material.

FIG. 11 illustrates an example of adjacent error diffusion and forward error diffusion.

FIGS. 12A and 12B illustrate an example of an embodiment of error diffusion in different layers.

### DETAILED DESCRIPTION OF THE PREFERRED EMBODIMENTS

The present invention extends to systems, methods, and apparatuses for dynamically controlling a three-dimensional (3D) printer. The systems, methods, and apparatuses operate through the deposition of materials during the creation of a target object. In some embodiments, the materials deposited through the three-dimensional printer are coreactive materials, and the 3D printer is a thermoset printer. As used here, a “target object” may refer to a portion of a physical object or a complete physical object that is being additively manufactured by the systems, method, and/or apparatuses described here. Additionally, as used herein, coreactive materials include thermoset materials. Note, although some of the embodiments described herein are related to thermal 3D printers configured to extrude coreactive materials, the principles described herein are also applicable to any other 3D printers.

Additive manufacturing using coreactive components has several advantages compared to alternative additive manufacturing methods. As used herein, “additive manufacturing” refers to the use of computer-aided design (e.g., through user generated files or 3D object scanners) to cause an additive manufacturing apparatus to deposit material, layer upon layer, in precise geometric shapes. Additive manufacturing using coreactive components can create stronger parts because the materials forming successive layers can be coreacted to form covalent bonds between the layers. Also, because the components have a low viscosity when mixed, higher filler content can be used. The higher filler content can be used to modify the mechanical and/or electrical properties of the materials, such as (but not limited to) density, thermal expansion, thermal conductivity, chemical resistance, glass transition temperature (Tg), extension at break, surface energy, electrical conductivity, and the built target object. Coreactive components can extend the chemistries used in additively manufactured parts to provide improved properties such as solvent resistance and thermal resistance.

Additionally, the ability to use a computer system to control the use of coreactive components within an additive manufacturing environment provides several advantages. For example, the computer system is able to dynamically control and adjust the flow rates, pump speed, gantry speed, and/or and tool paths of the coreactive components in ways that produce desired physical attributes of the resulting material. Such adjustments and control provide unique advantages within additive manufacturing.

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

The term “polymer” is meant to include prepolymer, homopolymer, copolymer, and oligomer.

Embodiments of the present disclosure are directed to the production of structural objects using 3D printing. A 3D object may be produced by forming successive portions or layers of an object by depositing at least two coreactive components onto a substrate and thereafter depositing additional portions or layers of the object over the underlying deposited portion or layer. Layers are successively deposited to build the 3D printed object. The coreactive components can be mixed and then deposited or can be deposited separately. When deposited separately, the components can be deposited simultaneously, sequentially, or both simultaneously and sequentially.

Deposition and similar terms refer to the application of a printing material comprising a coreactivating or coreactive composition and/or its reactive components onto a substrate (for a first portion of the object) or onto previously deposited portions or layers of the object. Each coreactive component may include monomers, prepolymers, adducts, polymers, and/or crosslinking agents, which can chemically react with the constituents of the other coreactive component.

The at least two coreactive components may be mixed together and subsequently deposited as a mixture of coreactive components that react to form portions of the object. For example, the two coreactive components may be mixed together and deposited as a mixture of coreactive components that react to form the coreactivating composition by delivery of at least two separate streams of the coreactive components into a mixing apparatus such as a static mixer or dynamic mixer to produce a single stream that is then deposited. The coreactive components may be at least partially reacted by the time a composition comprising the reaction mixture is deposited. The deposited reaction mixture may react at least in part after deposition and may also react with previously deposited portions and/or subsequently deposited portions of the object such as underlying layers or overlying layers of the object.

Alternatively, the two coreactive components may be deposited separately from each other to react upon deposition to form the portions of the object. For example, the two coreactive components may be deposited separately such as by using an inkjet printing system whereby the coreactive components are deposited overlying each other and/or adjacent to each other in sufficient proximity so the two reactive components may react to form the portions of the object. As another example, in an extrusion, rather than being homogeneous, a cross-sectional profile of the extrusion may be inhomogeneous such that different portions of the cross-sectional profile may have one of the two coreactive components and/or may contain a mixture of the two coreactive components in a different molar and/or equivalents ratio.

Furthermore, throughout a 3D-printed object, different parts of the object may be formed using different proportions of the two coreactive components such that different parts of an object may be characterized by different material properties. For example, some parts of an object may be rigid and other parts of an object may be flexible.

It will be appreciated that the viscosity, reaction rate, and other properties of the coreactive components may be adjusted to control the flow of the coreactive components and/or the coreactivating compositions (e.g., different monomers) such that the deposited portions and/or the object achieves and retains a desired structural integrity following deposition. The viscosity of the coreactive components may be adjusted by the inclusion of a solvent (such as, but not limited to, a reactive diluent, a resin, a pigment rheology modifier), or the coreactive components may be substantially free of a solvent or completely free of a solvent. In some embodiments, the solvent may be a solid material, such as a resin. In some embodiments, the solvent may be a liquid material. The viscosity of the coreactive components may be adjusted by the inclusion of a filler, or the coreactive components may be substantially free of a filler or completely free of a filler. The viscosity of the coreactive components may be adjusted by using components having lower or higher molecular weight. For example, a coreactive component may comprise a prepolymer, a monomer, or a combination of a prepolymer and a monomer. The viscosity of the coreactive components may be adjusted by changing the deposition temperature. The coreactive components may have a viscosity and temperature profile that may be adjusted for the particular deposition method used, such as mixing prior to deposition and/or ink jetting. The viscosity may be affected by the composition of the coreactive components themselves and/or may be controlled by the inclusion of rheology modifiers as described herein.

It can be desirable that the viscosity, yield stress, and/or the reaction rate be such that following deposition of the coreactive components the composition retains an intended shape. For example, if the viscosity is too low and/or the reaction rate is too slow a deposited composition may flow in a way that compromises the desired shape of the finished object. Similarly, if the viscosity is too high and/or the reaction rate is too fast, the desired shape may be compromised.

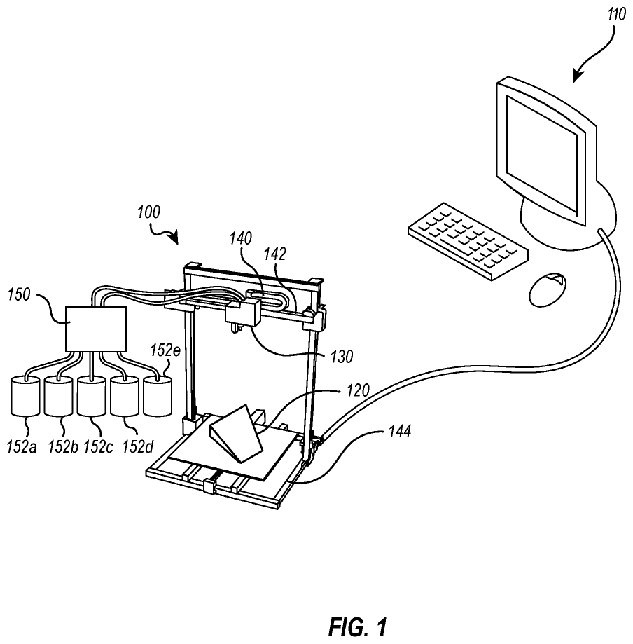

Turning now to the figures, FIG. 1 illustrates a system for 3D printing using coreactive components. The depicted system comprises a 3D printer 100 in communication with a computer system 110. While depicted as a physically separate component, the computer system 110 may also be wholly integrated within the 3D printer 100, distributed between multiple different electronic devices (including a cloud computing environment), or otherwise integrated with the 3D printer 100. As used herein, a “3D printer,” refers to any device capable of additive manufacture using computer-generated data files. Such computer-generated data files herein are referred to as “CAD files.”

The depicted 3D printer 100 is depicted with a target object 120 in the form of a wedge shape. The wedge shape comprises a trapezoid surface with a non-planar surface that is constructed by the 3D printer 100 using, at least in part, coreactive components. The 3D printer 100 also comprises a dispenser 130 that is attached to a movement mechanism 140. As used herein, a “dispenser” may comprise a dynamic nozzle, a static nozzle, injection device, a pouring device, a dispensing device, an extrusion device, a spraying device, or any other device capable of providing a controlled flow of coreactive components.

Additionally, the movement mechanism 140 is depicted as comprising a dispenser attached within a track 142 that is moveable in an X-axis direction along an arm and another set of tracks 144 in which the arm is able to move in a Y-axis direction. One will appreciate, however, that this configuration is provided only for the sake of example and explanation. In additional or alternative configurations, the movement mechanism 140 may comprise any system that is capable of controlling a position of the dispenser 130 with respect to a target object 120, including, but not limited to a system that causes the target object 120 to move with respect to the dispenser 130.

Further, the 3D printer 100 is connected to one or more containers 152(a-e) of coreactive components. In the depicted example, the coreactive components are accessed through a selectable manifold 150 that allows a user to select the desired containers 152(a-e) from which to draw coreactive components. One will appreciate, however, that the depicted system for 3D printing is merely exemplary. For example, in alternative cases the system may utilize a different configuration of coreactive components and the selectable manifold 150 or may not comprise a selectable manifold 150 at all.

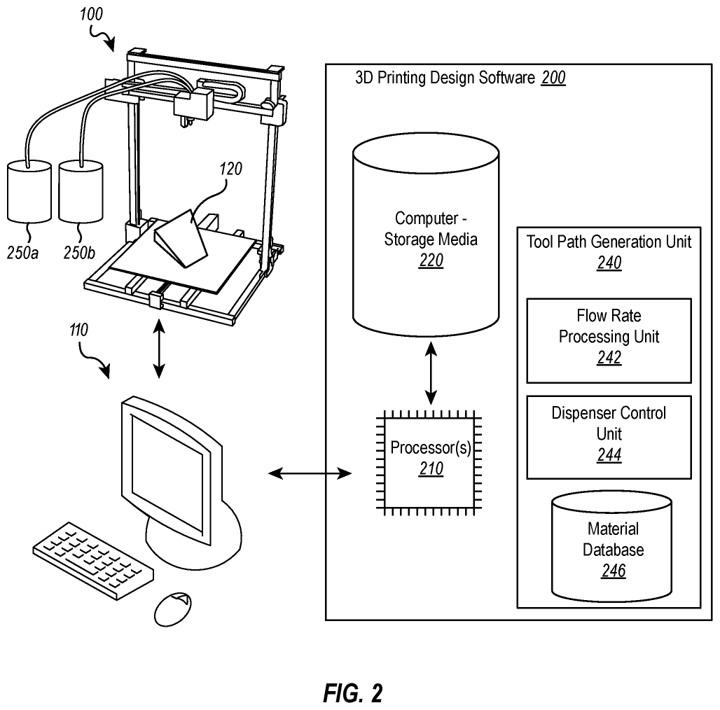

FIG. 2 illustrates a schematic of a computer system for thermoset 3D printing. The computer system 110 is shown as being in communication with the 3D printer 100. Additionally, various modules, or units, of a 3D Printing design software 200 are depicted as being executed by the computer system 110. In particular, the 3D Printing design software 200 is depicted as comprising a tool path generation unit 240, a flow rate processing unit 242, a dispenser control unit 244, and a material database 246. The tool path generation unit 240 is configured to generate a tool path and modify it in terms of machine language.

The depicted computer system for thermoset 3D printing is further shown as comprising a first coreactive component container 152a and a second coreactive component container 152b that are directly fed into the 3D printer 100. As such, the 3D printer 100 can extract coreactive components as desired from the first coreactive component container 152a and the second coreactive component container 152b. One will appreciate, however, that this configuration is merely exemplary and that in additional or alternative embodiments a different configuration of coreactive component containers may be utilized to provide coreactive components to the 3D printer 100.

As used herein, a “module” comprises computer executable code and/or computer hardware that performs a particular function. One of skill in the art will appreciate that the distinction between different modules is at least in part arbitrary and that modules may be otherwise combined and divided and still remain within the scope of the present disclosure. As such, the description of a component as being a “module” is provided only for the sake of clarity and explanation and should not be interpreted to indicate that any particular structure of computer executable code and/or computer hardware is required, unless expressly stated otherwise. In this description, the terms “unit”, “component”, “agent”, “manager”, “service”, “engine”, “virtual machine” or the like may also similarly be used.

The computer system 110 also comprises one or more processors 210 and one or more computer-storage media 220 having stored thereon executable instructions that when executed by the one or more processors 210 configure the computer system 110 to perform various acts. For example, the computer system 110 can receive an indication to cause the 3D printer 100 to print a non-planar surface. As used herein, an “indication” comprises any form of input received by the computer system 110. For example, the indication may comprise manual entry by a user, automatic actions executed by the computer system 110 or another remote computer system, the execution of a software application, the selection of a user interface element within a graphical user interface, the receipt of a data file, or any other form of input that causes the computer system 110 to perform a further action. Additionally, as used herein, a non-planar surface comprises any surface that reduces in thickness towards a particular end, such as a sloped and/or angled surface. For example, the wedge-shaped target object 120 comprises a non-planar surface. As such, a non-planar surface comprises a surface that is not planar with respect to a bottom surface of the target object.

Once the indication to print the non-planar surface of the target object 120 is received by the computer system 110, the tool path generation unit 240 generates a tool path to additively manufacture the target object 120. As used herein, a “tool path” refers to the path of the dispenser 130 as it manufactures the target object 120. Additionally, the “tool path” may also refer to the speed and/or flow rate of the dispenser 130 as it manufactures the target object 120. The tool path generation unit 240 generates the tool path such that the coreactive material is dispensed from the dispenser 130 at a rate and along a path that will create the target object 120.

In some circumstances, the tool path may require the dispenser 130 to layer coreactive material in layers on top of themselves. The flow rate processing unit 242 and dispenser control unit 244 calculate a target flowrate to ensure that the coreactive material properly bonds between the different layers. Such calculations may account for the reactive time of the coreactive material such that the layers are placed on top of each other before lower layers have time to fully cure. As such, the generation of the first tool path may be based, at least in part, upon the target flow rate. As explained above, such information relating to the amount of time that different coreactive components remain reactive is provided by the material database 246.

As used herein, the “flow rate” (also referred to as “extrusion rate”) comprises the rate at which one or more components of the material are dispensed from the dispenser 130. The flow rate may be controllable on a per-component basis. For example, the tool path generation unit 240 comprises a flow rate processing unit 242 that determines and controls the target flow rate for dispensing coreactive material to create the target object 120. In some embodiments, the flow rate processing unit 242 may be configured to turn on and/or off one or more valves at the dispenser 130, and/or control flow rate based on E commands (which invoke a system editor to edit statements in a stack). In some embodiments, the dispenser control unit 244 may be configured to control a linear movement of the dispenser 130.

The flow rate processing unit 242 may be configured to manipulate the flow rate of the coreactive material by changing properties of the coreactive components within the coreactive material while making the target object 120. It will be appreciated that the viscosity, reaction rate, and other properties of the coreactive components may be adjusted to control the flow of the coreactive components and/or the thermosetting compositions such that the deposited portions and/or the object achieves and retains a desired structural integrity following deposition. The viscosity of the coreactive components may be adjusted by the inclusion of a solvent, or the coreactive components may be substantially free of a solvent or completely free of a solvent. The viscosity of the coreactive components may be adjusted by the inclusion of a filler, or the coreactive components may be substantially free of a filler or completely free of a filler. The viscosity of the coreactive components may be adjusted by using components having lower or higher molecular weight. For example, a coreactive component may comprise a prepolymer, a monomer, or a combination of a prepolymer and a monomer. The viscosity of the coreactive components may be adjusted by changing the deposition temperature. The coreactive components may have a viscosity and temperature profile that may be adjusted for the particular deposition method used, such as mixing prior to deposition and/or ink jetting. The viscosity may be affected by the composition of the coreactive components themselves and/or may be controlled by the inclusion of rheology modifiers as described herein.

It can be desirable that the viscosity and/or the reaction rate be such that following deposition of the coreactive components the composition retains an intended shape. For example, if the viscosity is too low and/or the reaction rate is too slow a deposited composition may flow in a way the compromises the desired shape of the finished object. Similarly, if the viscosity is too high and/or the reaction rate is too fast, the desired shape may be compromised.

For example, the coreactive components that are deposited together may each have a viscosity at 25° C. and a shear rate at 0.1 s⁻¹ from 5,000 centipoise (cP) to 5,000,000 cP, from 50,000 cP to 4,000,000 cP, or from 200,000 cP to 2,000,000 cP. The coreactive components that are deposited together may each have a viscosity at 25° C. and a shear rate at 1,000 s⁻¹ from 50 centipoise (cP) to 50,000 cP, from 100 cP to 20,000 cP, or from 200 to 10,000 cP. Viscosity values can be measured using an Anton Paar MCR 301 or 302 rheometer with a gap from 1 mm to 2 mm.

Additionally, the viscosity and/or reaction rate can be adjusted to control the actual bead size, or layer size, that is dispensed by the dispenser 130. As used herein, a “bead” comprises a layer of material dispensed by the dispenser 130 on a tool path. Similarly, as used herein the “bead size” comprises one or more dimensions of a layer that is being dispensed by the dispenser 130. For example, a bead size may comprise a height of the bead, a radius of a bead, a width of a bead, or any other physical dimension of the bead. It will be appreciated that while the word “bead” is used herein, the actual layer need not bear a physical resemblance to a conventional bead shape.

Additionally or alternatively, the dispenser control unit 250 may adjust the characteristics of the 3D printer 100 in order to achieve a desired flow rate. For example, the dispenser control unit 250 may cause the dispenser 130 to travel faster or slower in order to achieve the desired bead size, deposition rate, viscosity, and/or reaction rate. For example, if the dispenser 130 is dispensing coreactive materials at a constant rate and the dispenser control unit 250 causes the dispenser to travel at a faster speed during deposition, the resulting bead size will be smaller. Similarly, the dispenser control unit 250 may cause the dispenser 130 to dispense the coreactive material at higher or lower rates based upon a desired flow rate and/or bead size. As such, the flow rate processing unit 242 may adjust the properties of the coreactive components within the material and/or the dispenser control unit 250 may adjust the mechanical operation of the 3D printer 100 in order to achieve a desired flowrate and/or bead size.

In some configurations, the 3D printer 100 may be capable of utilizing multiple different types of material to manufacture the target object 120. These different materials may comprise different combination of coreactive components. For example, FIG. 1 depicts one or more containers 152(a-e) of coreactive components that each may comprise a different type of coreactive component. Upon receiving the indication of the material, the tool path generation unit 240 accesses from a material database 246 characteristics of the material. In some cases, the indication of the material comprises a specific mixture of coreactive components, such as a specific mixture of coreactive components provided by the one or more containers 152(a-e) of coreactive components. The characteristics of the material comprise a viscosity of the material and/or various other attributes relating to the reactivity of the material. Using the information from the material database 246 and the processes described above, the tool path generation unit 240 determines the target flow rate and/or bead size using characteristics of the material.

Additionally, in some configurations, the coreactive components may utilize an external stimulus, such as UV light during the reaction process. In such cases, the 3D printer 100 may comprise a UV light source that is controllable by the computer system 110. The 3D printer 100 may be configurable to dispense the coreactive material and cure the material with a UV light source. Various other stimuli may be similarly implemented by the computer system 110 such that the stimuli are applied to the coreactive material during and/or after the dispensing of the coreactive material.

Returning now to the printing of the non-planar surface of the target object 120, the 3D printing design software 200 can calculate multiple different bead sizes for creating the non-planar surface using thermoset component. In particular, conventional methods for creating non-planar surfaces using thermoplastics result in a jagged step pattern of thermoset tool paths extending down the non-planar surface. In contrast, the 3D printing design software 200 can print non-planar surfaces of the target object 120 using different sequentially smaller bead sizes and controlling the viscosity of the coreactive material to create a smooth non-planar surface. In some embodiments, one or more attributes associated with different sequentially smaller bead sizes are determined based on an angle of the non-planar surface. In some embodiments, the attributes associated the different sequentially smaller bead sizes are determined based on a height (i.e., z axis) configuration for a top layer and/or layer changes. The one or more attributes may include (but are not limited to) a bead width, a nozzle height, a travel speed, and/or an extrusion amount.

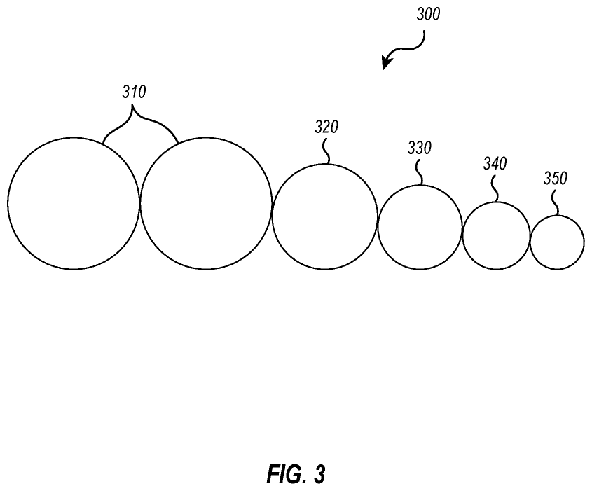

For instance, FIG. 3 illustrates a side view of different bead sizes. In the depicted example a first set of bead sizes 310 are at the top of a taper 300. The second bead size 320 is smaller than the first set of bead sizes. Similarly, the third bead size 330 is smaller than the second bead size 320, the fourth bead size 340 is smaller than the third bead size 330, and the fifth bead size 350 is smaller than the fourth bead size 340. The sequentially decreasing bead sizes create a natural taper.

The tool path generation unit 240 can calculate the number of sizes of beads needed along the tool path through the use of geometric relationships and material properties of the coreactive material, such as viscosity. For example, the tool path generation unit 240 can identify an angle and length of a taper. Using this information, the tool path generation unit 240 can calculate a number and size of different beads needs to form the desired taper. For instance, the tool path generation unit 240 may identify both the largest bead size and the smallest bead size that the dispenser 130 can create using a particular coreactive material, while maintaining the desired material attributes. Using these two data points, the tool path generation unit 240 can segment the length of the taper into fractionally smaller bead sizes.

For example, the tool path generation unit 240 determines a length of the non-planar surface, determines at least one angle of taper associated with the non-planar surface, and based upon the length of the non-planar surface and the at least one angle of taper, calculates a geometric ratio of bead size differences between adjacent thermoset print lines. The ratio is chosen so that the desired angle of the surface is achieved. For instance, the tool path generation unit 240 can utilize the ratio of tangent of the taper angle to identify the desired height of each sequential bead size. Using this concept, the tool path generation unit 240 can create a command to generate the multiple different bead sizes at specific locations within a printing area. As used herein, the printing area comprises the physical area within which the 3D printer 100 is able to dispense coreactive material.

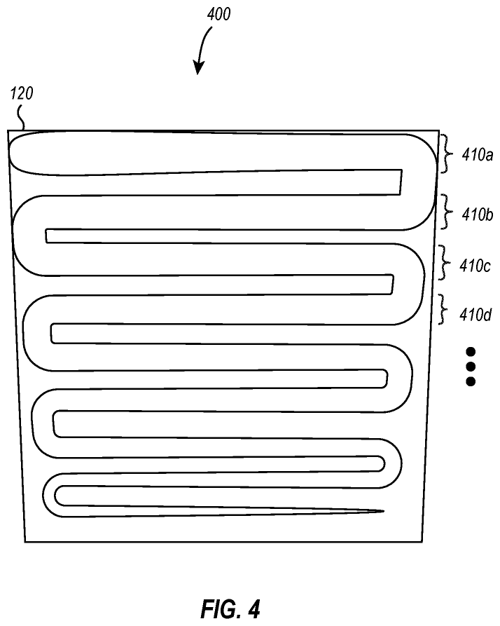

For example, FIG. 4 illustrates varying bead sizes 410(a-d) along a tool path 400. In particular, the tool path generation unit 240 calculates the bead sizes 410(a-d) needed to achieve the desired taper. The tool path generation unit 240 generates a tool path 400 that is configured to sequentially dispense the desired bead sizes 410(a-d) along the tool path 400.

For instance, the tool path generation unit 240 may generate tool path 400 that dispenses the coreactive material at a constant rate and varies its speed. As such, the tool path generation unit 240 can create a command to change a speed of the dispenser 130 within the three-dimensional printer 100, wherein the change in speed conforms to the desired bead size. For example, while creating bead size 410a the dispenser 130 may move at a first speed and then while creating bead size 410b the dispenser 130 may move at a faster speed such that a smaller bead size 410b is created. As such, typically an increase in speed correlates to a smaller bead size. The dispenser 130 may continually move at a faster speed for each sequential bead size 410(a-d) such that the bead sizes sequentially decrease down the non-planar surface of the target object 120.

Additionally or alternatively, the tool path generation unit 240 may create a command to change a flow rate of thermoset material from the three-dimensional printer 100, wherein the change in flow rate conforms to the desired bead size. For instance, the tool path generation unit 240 may adjust the flow of coreactive material along the tool path 400 such that a relatively higher flow rate is used to create bead size 410a, while a relatively lower flow rate is used to create bead size 410b. As such, higher flow rates may correlate to larger bead sizes while relatively lower flow rates may correlate to relatively smaller bead sizes. One will appreciate that a number of different methods may be used alone or in combination to manipulate the bead size of the coreactive materials dispensed from the dispenser 130.

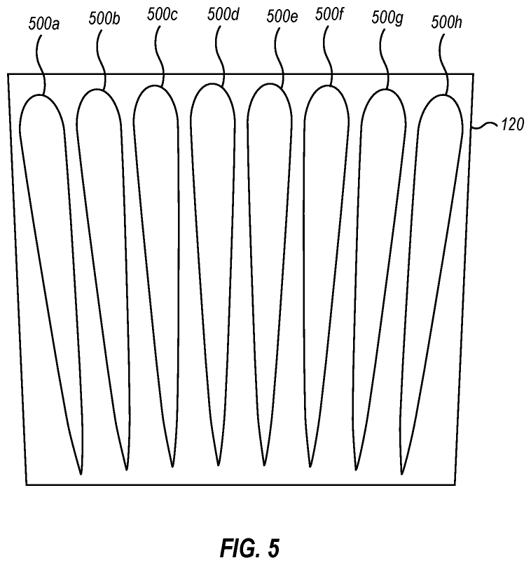

FIG. 5 illustrates an alternative configuration for varying bead sizes along multiple tool paths 500(a-h). In this depicted example, the tool path generation unit 240 generates tool paths 500(a-h) that run parallel to the taper with continuously decreasing bead sizes along the taper. Within the example of FIG. 4, the bead sizes 410(a-d) are substantially discrete in that each line that runs perpendicular to the taper is a substantially consistent bead size 410(a-d). In contrast, in FIG. 5 the bead size is continuously decreased along the length of a particular tool path 500(a-h). Accordingly, one will appreciate in view of this disclosure that the bead sizes can be adjusted in a number of different ways to create a non-planar surface.

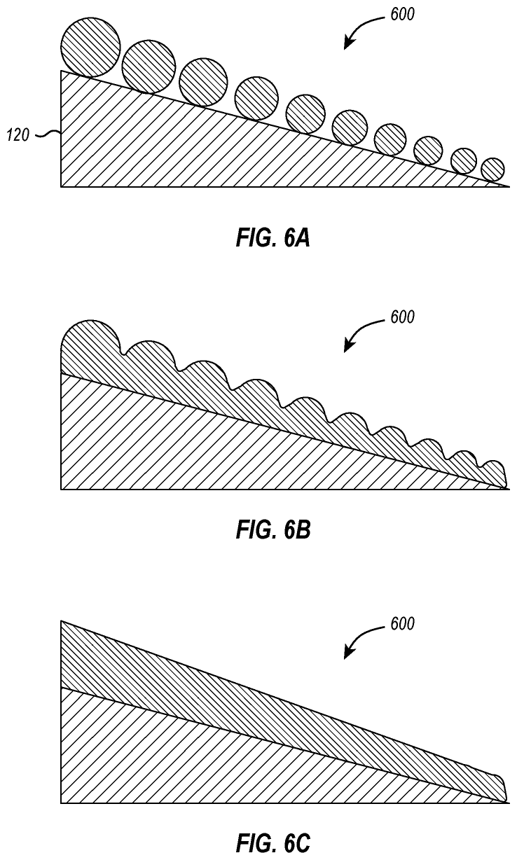

FIG. 6A illustrates a side view of different bead sizes along a non-planar surface 600 of the target object 120. The side view depicts exemplary bead sizes that are completely round. One of skill in the art will appreciate that the coreactive material will not maintain a perfectly round shape once dispensed. Nevertheless, for the sake of example and explanation the sequential bead sizes are depicted. FIG. 6B illustrates another side view of different bead sizes along a non-planar surface 600. In this depicted example, the coreactive beads are beginning to settle as dictated by the viscosity of the coreactive material. FIG. 6C illustrates another side view of different bead sizes along a non-planar surface 600. FIG. 6C depicts the coreactive material after the individual beads have settled into a smooth non-planar surface 600.

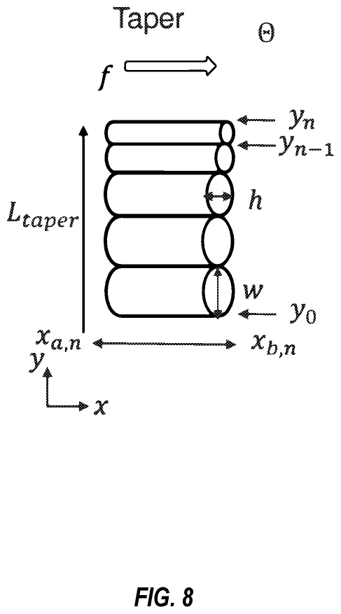

In some embodiments, based on a dimension of the desired non-planar surface, the computer system 110 is configured to determine bead width, nozzle height, travel speed, and/or extrusion amount, and based on the determined bead width, nozzle height, travel speed, and/or extrusion amount, the computer system 110 generates commands to cause the printer 100 to dispense beads according to the commands, creating the desired tapered shape. The FIG. 8 illustrates an example of dimensions of a desired non-planar surface. Based on the dimensions of the desired non-planar surface, bead width, nozzle height, travel speed, and/or extrusion amount may be computed to cause the printer to create the desired non-planar surface. In some embodiments, the following equations may be used to compute a bead width Wₙ, nozzle height hₙ, travel speed fₓ, and/or extrusion amount E, where n is a current iteration, and N is a total iterations.

$${w}_{n} = \frac{{w}_{f} - {w}_{i}}{N} {x}_{n} + {w}_{i} \qquad Equation ( 1 )$$

$${h}_{n} = \frac{{h}_{f} - {h}_{i}}{Y} y + {h}_{i} OR {h}_{i} - Tan ( π - θ ) * ( {x}_{n} - {x}_{n - 1} ) \qquad Equation ( 2 )$$

$${f}_{x} = \frac{( {x}_{n} - {x}_{n - 1} )}{{w}^{2}} * {f}_{i} \qquad Equation ( 3 )$$

$$E = ( \frac{{y}_{n} - {y}_{n - 1}}{{w}_{i}} ) * ( \frac{{x}_{n} - {x}_{n - 1}}{{h}_{i}} ) * ( {y}_{a , n} - {y}_{b , n} ) \qquad Equation ( 4 )$$

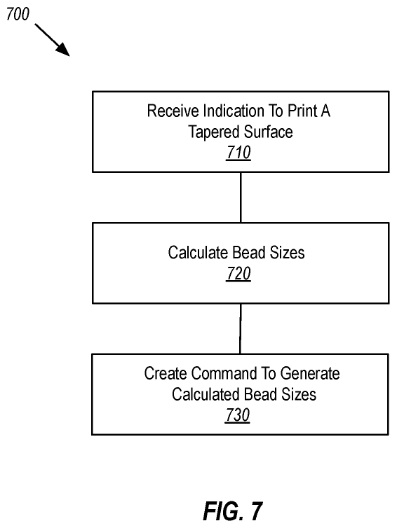

FIG. 7 illustrates a flowchart of steps for a method 700 of dynamically controlling a thermoset three-dimensional (3D) printer. The depicted method includes an act 710 of receiving an indication to print a non-planar surface. Act 710 comprises receiving an indication to cause a thermoset three-dimensional printer 100 to print a non-planar surface. For example, as depicted and described with respect to FIG. 1, the computer system 110 may comprise a command that causes the 3D printer 100 to print target object 120, which includes a non-planar surface 600.

Additionally, method 700 may include an act 720 of calculating beads sizes. Act 720 comprises calculating multiple different bead sizes for creating the non-planar surface 600 using thermoset components. For example, as depicted and described in FIGS. 1 and 4, the tool path generation unit 240 can identify an angle and length associated with the taper. Using this information, the tool path generation unit 240 can calculate the location and bead size of the different beads using conventional geometric ratios.

Method 700 can also include an act 730 of creating a command to generate the calculated bead sizes. Act 730 comprises creating a command to generate the multiple different bead sizes at locations within a printing area. For example, as depicted in FIG. 6A-6C the computer system 110 can cause the 3D printer 100 to print the non-planar surface 600.

Note, even though the drawings illustrate a tapered surface, any non-planar surface may be produced based on the principles described herein, because the taper is merely a special case of any non-planar surface.

Further, during the experimenting process, the inventors noted that certain extrusion errors might repeatedly occur under certain circumstances. In some embodiments, an extrusion error distribution is identified and parameterized, such that the 3D printer can be configured to adapt these parameters to match what the rheology indicates.

Because of the segmentation of the process due to gCode execution, the extrusion rate is divided into qualitied segments. However, for different extrusion material, a different natural lag may occur, i.e., the actual extrusion rate is behind the intended extrusion rate indicated by machine-readable commands. To mitigate the lag of the extrusion material, in some embodiments, heavier extrusion rates are implemented on a travel down of a slope compared to extrusion rates implemented on a travel up of the slope. Such embodiments also provide a means to average the two adjacent extrusion beads so that an effective intermediate extrusion rate between the two adjacent extrusion rates is achieved.

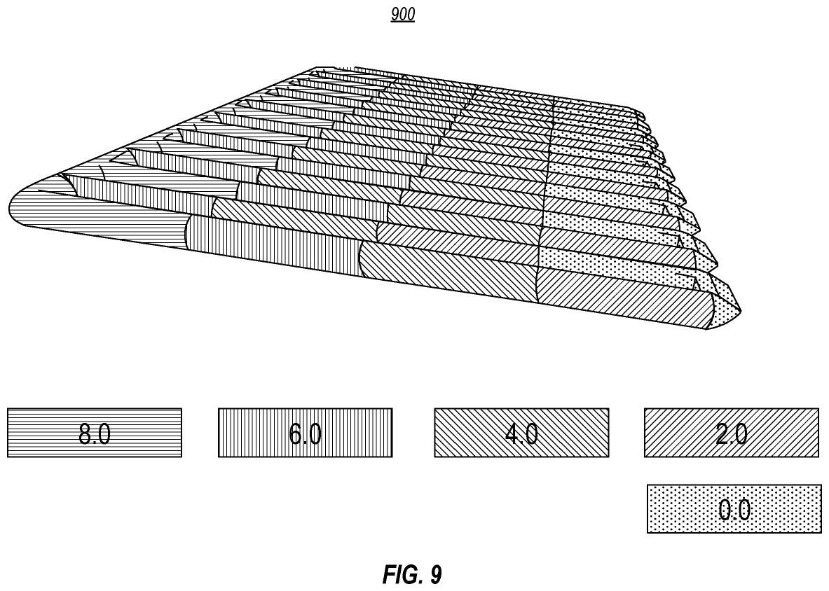

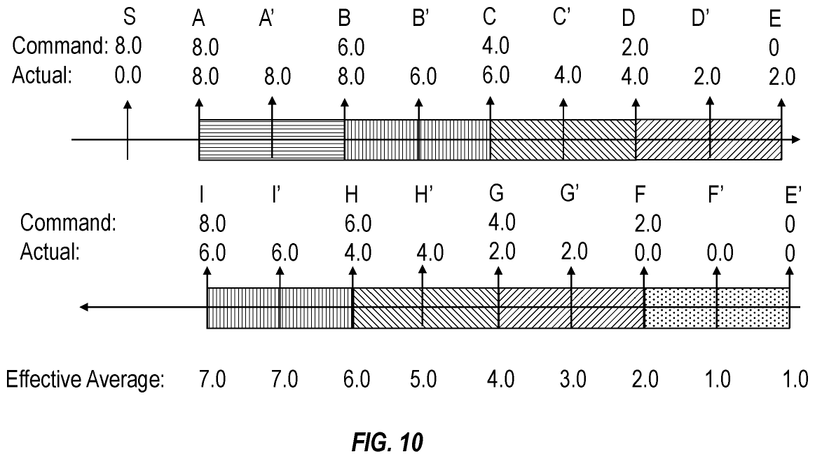

FIGS. 9-10 illustrate an example embodiment for implementing heavier extrusion rates compared on travel down of a slope compared to extrusion rates on travel up of the slope. FIG. 9 illustrates an example tool path 900 along a slope (i.e., a tapered surface). The tool path is divided into multiple segments A-B, B-C, C-D, D-E, E-F, F-G, G-H, H-I, and so on and so forth. The multiple segments A-B, B-C, C-D, D-E, E-F, F-G, G-H, H-I corresponding to different extrusion rates indicated by command(s) are shown as a different pattern. For example, the extrusion rate indicated by command(s) in segment A-B is 8.0 shown as bluish-green, the extrusion rates indicated by command(s) in segments B-C and H-I are 6.0 shown as green, the extrusion rates indicated by command(s) in segments C-D and G-H are 4.0 shown as yellow, the extrusion rates in segments D-E and F-G are 2.0 shown as light orange, and the extrusion rate in segment EF is 0.0 shown as orange.

Note, in reality, the extrusion rate only changes in a predetermined minimum discrete unit. When the minimum discrete unit is 2.0 as shown in FIGS. 9-10, the extrusion rates are always times of 2.0. In some cases, the limitation of the minimum discrete unit could cause errors and/or imperfections of the printed 3D objects.

Further, the natural lag of an extrusion material could also cause errors and/or imperfections of the printed 3D objects. In particular, the natural lag would cause an actual extrusion rate to be delayed compared to the command. FIG. 10 illustrates the different extrusion rates in the travel down and travel up of the slop shown in FIG. 9 to compensate for the lag of the extrusion material. The top section of FIG. 10 illustrates the extrusion rates indicated by command(s) and the actual extrusion rates due to the lag in the travel down of the slope of FIG. 9. The bottom section of FIG. 10 illustrates the extrusion rates dedicated by command(s) and the actual extrusion rates due to the lag in the travel up of the slope of FIG. 9. As illustrated, the extrusion rates indicated by command(s) in the travel down of the slope are 8.0 (during section A-B), 6.0 (during section B-C), 4.0 (during section C-D), 2.0 (during section D-E); the extrusion rates indicated by command(s) in the travel up of the slope are 0 (during section E′-F), 2.0 (during section F-G), 4.0 (during section G-H), and 6.0 (during section H-I). As such, the set of extrusion rates (e.g., 8.0, 6.0, 4.0, 2.0) indicated by command(s) in the travel up of the slope are greater than the set of the extrusion rates (e.g., 0, 2.0, 4.0, 6.0) indicated by command(s) in the travel down of the slope.

Further, due to the lag of the extrusion material, the actual extrusion rates have a delay compared to the extrusion rates indicated by command(s). As illustrated in FIG. 10, in the travel down of the slope, point S is a point before point A, which could be before point A in time and/or in physical space). A command for an extrusion rate of 8.0 is initiated at point S. However, due to the lag, the actual extrusion rate at point S is 0.00, and not until at point A, the actual extrusion rate reaches 8.0. Similarly, at point B, a command changes the extrusion rate from 8.0 to 6.0; however, the actual extrusion rate at point B remains at 8.0, and not until at point B′ (which is a point between B and C), the actual extrusion rate reaches 6.0. Again, at point C, a command changes the extrusion rate from 6.0 to 4.0, while the actual extrusion rate at point C remains 6.0, and not until at point C′ (which is a point between C and D), the actual extrusion rate reaches 4.0. Again, at point D, a command changes the extrusion rate from 4.0 to 2.0, the actual extrusion rate at point D remains at 4.0, and not until at point D′ (which is a point between D and E), the actual extrusion rate reaches 2.0.

The same lag occurs in the travel up of the slope, which causes the actual extrusion rate to be 0 at point E′, 0 at point F′ (which is a point between E′ and F), 0 at point F, 2.0 at point G′ (which is a point between F and G). 2.0 at point G, 4.0 at point H′ (which is a point between G and H), 4.0 at point H, 6.0 at point I′ (which is a point between H and I), and 6.0 at point I.

Referring back to FIG. 9, points A and I are adjacent on the slope (or a non-planar surface); similarly, points B and H are adjacent, points C and G are adjacent, points E and E′ are adjacent, points A′ and I′ are adjacent, point B′ and H′ are adjacent, point C′ and G′ are adjacent, and point D′ and F′ are adjacent. Turning now to FIG. 10 again, due to the different extrusion rates formed in the travel down and travel up of the slope, an effective average actual extrusion rate at points A and I is 7.0=(8.0+6.0)/2; an effective average actual extrusion rate at points A′ and I′ is 7.0=(8.0+6.0)/2; an effective average natural extrusion rate at points B and H is 6.0=(8.0+4.0)/2; an effective average natural extrusion rate at point B′ and H′ is 5.0=(6.0+4.0)/2; an effective average actual extrusion rate at points C and G is 4.0=(6.0+2.0)/2; an effective average actual extrusion rate at points C′ and G′ is 3.0=(4.0+2.0)/2; an effective average actual extrusion rate at points D and F is 2.0=(4.0+0.0)/2; an effective average actual extrusion rate at points D′ and F′ is 1.0=(2.0+0.0)/2; and an effective average actual extrusion rate at points E and E′ is 2.0=(2.0+0.0)/2. As such, while the extrusion rate only changes in discrete units of 2.0, the effective averages of the adjacent extrusion rates (e.g., 7.0, 6.0, 5.0, 4.0, 3.0, 2.0, and 1.0) provide a finer resolution.

Note, the numbers 8.0, 6.0, 4.0, 2.0 used to represent extrusion rates are merely examples. Regardless of the exact number of the minimum discrete unit of the extrusion rates, the same principles described above are applicable, and the effective average extrusion rates would provide a finer resolution that is finer than the minimum discrete unit of the extrusion rates.

Having an extrusion rate in travel down of a slope to be greater than that of travel up of the slope is merely an example of an embodiment that can mitigate or diffuse errors or imperfections of an adjacent tool path on a tapered surface. The principles described herein may also be implemented to mitigate and/or diffuse errors and/or imperfections that occurred at an adjacent tool path or caused by a lag of the extrusion material in the same tool path on any non-planar surface.

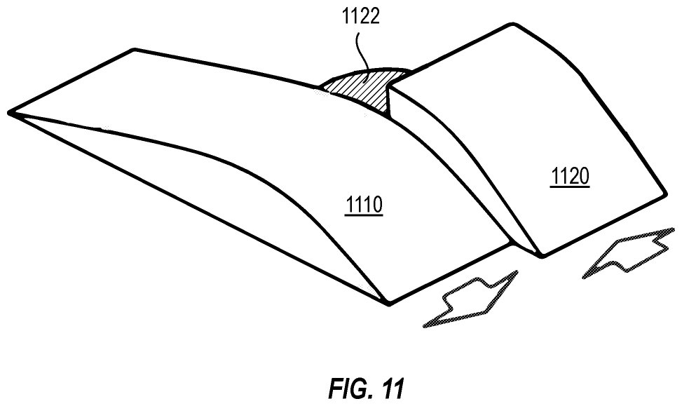

FIG. 11 illustrates an example of two adjacent tool paths 1110 and 1120. The extrusion rate at the current position 1122 is computed based on both parameters associated with the adjacent tool path 1110 and parameters associated with its own tool path 1120. In some embodiments, the diffusion is based on a 3-dimensional (x, y, z three spatial dimensions) or a 4-dimensional (x, y, z, three spatial dimensions and t, a time dimension) Floyd-Steinbrg filter, which adds a residual quantization error of a point onto its neighboring point. In some embodiments, the computation associated with the diffusion of errors and/or imperfections related to the parameters of the adjacent tool path 1110 is referred to as adjacent error diffusion, and the computation associated with the diffusion of errors and/or imperfections related to the parameters of its own tool path 1120 is referred to as forward error diffusion.

Although as shown in FIG. 11, the adjacent error diffusion and forward error diffusion occur in the same layer of a tool path, the same principles described herein may also be implemented in different layers to adjust an extrusion rate of a first point in a first layer to diffuse an error that occurred in a second point in a second layer that is adjacent to the first layer.

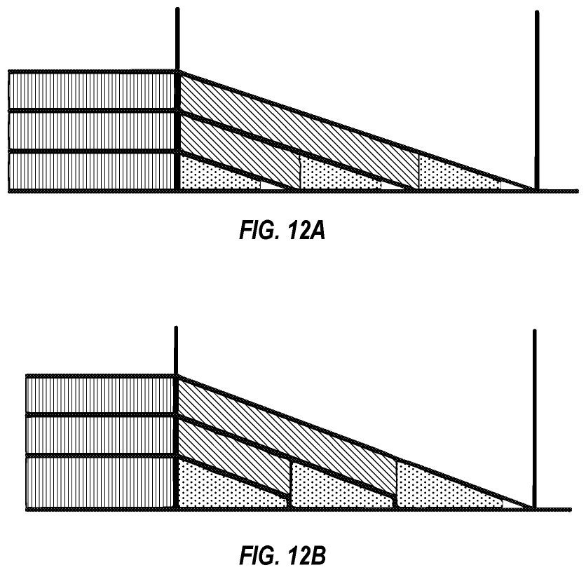

FIGS. 12A and 12B illustrate an example of an embodiment of error diffusion in different layers. FIG. 12A illustrates that when printing a tapered surface, the bottom layers often create small gaps due to the minimum discrete unit of the extrusion rate. In some embodiments, the extrusion rates along the tool paths may be adjusted to reduce or even eliminate such gaps. FIG. 12B illustrates the result using the adjusted extrusion rates. As illustrated in FIG. 12B, with the adjusted extrusion rates, most of the gaps are eliminated (except the one at the far right edge).

Further, notably, each of the points in a tool path has four dimensions, including 3-dimensions in the physical space and a time dimension (not shown). Depending on the actual rate, the timing of the extrusion change (including the speed of movement of the extruder) can also be adjusted. As such, the computation of the extrusion rate is associated with not only parameters associated related to 3 physical space dimensions, but also parameters associated with a time dimension.

These parameters associated with different dimensions may be different for different extrusion materials. In some embodiments, a separate set of values is compiled for each type of material and stored in a computer-readable storage. For example, a separate table may be generated for each type of material. The 3D printer or a computing system that is coupled to the 3D printer is configured to retrieve the different sets of values based on the materials used in different printing jobs and generate gCode that implements the various error diffusions described above.

In some embodiments, extrusion error diffusion is performed based on an error function that measures the difference between the desired extrusion rate and the actual extrusion rate. The error function is shown in Equations (5) and (6) below.

$$E ( x , y , z ) = D ( x , y , z ) - A ( x , y , z ) , \qquad Equation ( 5 )$$

where E is the error function at a particular position (x, y, z), D is the desired extrusion rate, and A is the actual extrusion rate.

As briefly discussed above, in some embodiments, time t is another parameter that may be considered in the error diffusion. When time t is considered, the error function is shown below in Equation (1).

$$E ( x , y , z , t ) = D ( x , y , z , t ) - A ( x , y , z , t ) , \qquad Equation ( 6 )$$

where E is the error function at a particular position (x, y, z) at a particular time t, D is the desired extrusion rate, and A is the actual extrusion rate.

Using the error function described above in Equation (5) and/or Equation (6), a total volume equals the current error so that no additional material is unnecessarily added or removed, and a sharpening effect for the resolution of the parts details can be achieved. The error function for error diffusion may be implemented at a computing system that is connected to a 3D printer or at a printer.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The invention is further described by the following aspects.

According a first aspect, a computer system for dynamically controlling a three-dimensional printer is provided, comprising: one or more processors; and one or more computer-readable media having stored thereon executable instructions that when executed by the one or more processors configure the computer system to, preferably a method according to any one of aspects sixteen to twenty-four: receive an indication to cause a three-dimensional printer to print a non-planar surface of a three-dimensional object having a particular shape; calculate multiple different bead sizes for creating the non-planar surface using components of the three-dimensional printer; and create a command to generate the multiple different bead sizes or ratios at locations within a printing area.

Aspect two relates to the computer system of aspect one, wherein creating a command to generate the multiple different bead sizes at specific locations within the printing area comprises: creating a command to change an extrusion rate of material from the three-dimensional printer, wherein the change in extrusion rate conforms to a desired bead size or a location having a particular height where one or more beads are to be deposited.

Aspect three relates to the computer system of any one of aspects one or two, wherein calculating multiple different bead sizes for creating the non-planar surface using components of the three-dimensional printer further comprises: identifying a plurality of parameters that are related to errors that may be caused by a plurality of limitations of the three-dimensional printer, the plurality of limitations including at least one of (1) a minimum bead size that the three-dimensional printer is capable of generating; or (2) a natural lag of an extrusion material that forms beads; and calculating multiple different bead sizes based on the plurality of parameters.

Aspect four relates to the computer system of any one of aspects one to three, wherein calculating multiple different bead sizes for creating the non-planar surface using components of the three-dimensional printer further comprises computing a difference between a desired extrusion rate and an actual extrusion rate.

Aspect five relates to the computer system of any one of aspects one to four, wherein calculating multiple different bead sizes based on the plurality of parameters comprises computing a bead size (1) to diffuse a first error caused by the natural lag of the extrusion material, (2) to diffuse a second error occurring on an adjacent tool path on a same layer, and/or (3) to diffuse a third error occurring on an adjacent tool path on a different layer.

Aspect six relates to the computer system of any one of aspects one to five, wherein a first tool path of travel down a slope has a first set of bead sizes, a second tool path of travel up the slope has a second set of bead sizes, and an average size of the first set of bead sizes is greater than that of the second set of bead sizes.

Aspect seven relates to the computer system of aspect six, wherein the first tool path and the second tool path are adjacent on the slope, and average effective bead sizes of the first tool path and the second tool path have a finer resolution than a resolution of the three-dimensional printer.

Aspect eight relates to the computer system of any one of aspects one to seven, wherein creating a command to generate the multiple different bead sizes at specific locations within the printing area comprises interpolating a particular coordinate within the printing area.

Aspect nine relates to the computer system of aspect eight, wherein interpolating a particular coordinate within the printing area comprises determining at least one of a bead width, a nozzle height, a travel speed, or an extrusion amount based on the particular shape of the three-dimensional object.

Aspect ten relates to the computer system of any one of aspects one to nine, wherein the three-dimensional printer is a thermoset printer.

Aspect eleven relates to the computer system of any one of aspects one to ten, wherein the system comprises a three-dimensional printer.

Aspect twelve relates to the computer system of any one of aspects one to eleven, wherein calculate multiple different bead sizes are obtained by adapting the viscosity, the reaction rate, and/or the composition of coreactive components.

Aspect thirteen relates to the computer system of any one of aspects one to twelve, wherein calculate multiple different bead sizes comprises identify an angle and/or length of a taper (or slope) of the surface and calculate a number and size of different beads needed to form the desired taper (slope).

Aspect fourteen relates to the computer system of any one of aspects one to thirteen, wherein calculate multiple different bead sizes comprises a tool path that run parallel to the taper with continuously decreasing bead sizes along the taper and/or a tool path, wherein each line runs perpendicular to the taper and each line has a different bead size.

Aspect fifteen relates to the computer system of any one of aspects one to fourteen, wherein calculate multiple different bead sizes comprises calculate the location and bead size of the different beads preferably using geometric ratios of the taper.

According a sixteenth aspect, a computer-implemented method for dynamically controlling a three-dimensional printer is provided, the computer-implemented method executed on one more processor, preferably as defined in any one of aspects one to fifteen, the computer-implemented method comprising: receiving an indication to cause a three-dimensional printer to print a non-planar surface; calculating multiple different bead sizes for creating the non-planar surface; and creating a command to generate the multiple different bead sizes at specific locations within a printing area.

Aspect seventeen relates to the computer system of aspect sixteen, wherein creating a command to generate the multiple different bead sizes at specific locations within the printing area comprises: creating a command to change an extrusion rate of material from the three-dimensional printer, wherein the change in extrusion rate conforms to a desired bead size.

Aspect eighteen relates to the computer system of any one of aspects sixteen or seventeen, wherein a higher extrusion rate correlates to a larger bead size.

Aspect nineteen relates to the computer system of any one of aspects sixteen or seventeen, wherein the method is able to dynamically control and adjust the flow rates, pump speed, gantry speed, and/or and tool paths of coreactive components to generate the multiple different bead sizes at specific locations within a printing area.

Aspect twenty relates to the computer system of any one of aspects sixteen to nineteen, wherein creating a command to generate the multiple different bead sizes at specific locations within the printing area comprises: creating a command to change a speed of a dispenser within the three-dimensional printer, wherein the change in speed conforms to a desired bead size.

Aspect twenty-one relates to the computer system of any one of aspects sixteen to twenty, wherein an increase in speed correlates to a smaller bead size.

Aspect twenty-two relates to the computer system of any one of aspects sixteen to twenty-one, further comprising causing the three-dimensional printer to dispense the multiple different bead sizes at specific locations within the printing area.

Aspect twenty-three relates to the computer system of any one of aspects sixteen to twenty-two, wherein the non-planar surface is a non-planar surface, and calculating multiple different bead sizes for creating the non-planar surface using three-dimensional components comprises: determining a length of the non-planar surface; determine at least one angle of taper associated with the non-planar surface; and based upon the length of the non-planar surface and the at least one angle of taper, calculating a geometric ratio of bead size differences between adjacent print lines.

Aspect twenty-four relates to the computer system of any one of aspects sixteen to twenty-three, wherein creating a command to generate the multiple different bead sizes at specific locations within the printing area comprises interpolating a particular coordinate within the printing area.

Aspect twenty-five relates to the computer system of aspect twenty-four, wherein interpolating a particular coordinate within the printing area includes computing at least one of a bead width, a nozzle height, a travel speed, or an extrusion amount, and creating a command, causing the three-dimensional printer to print based on the computed bead width, nozzle height, travel speed, or extrusion amount.

According a twenty-sixth aspect, a computer-readable media comprising one or more physical computer-readable storage media having stored thereon computer-executable instructions that, when executed at a processor, cause a computer system to perform a method for dynamically controlling a three-dimensional printer, preferably a method as defined in any one of aspects sixteen to twenty-four, the method comprising: receiving an indication to cause a three-dimensional printer to print a non-planar surface; calculating multiple different bead sizes for creating the non-planar surface using components of the three-dimensional printer; and creating a command to generate the multiple different bead sizes at specific locations within a printing area.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-20. (canceled)

21. A computer system for dynamically controlling a three-dimensional printer, comprising:
one or more processors; and
one or more computer-readable media having stored thereon executable instructions that when executed by the one or more processors configure the computer system to:
receive an indication to cause a three-dimensional printer to print a non-planar surface of a three-dimensional object having a particular shape;
calculate multiple different bead sizes or ratios for creating the non-planar surface using components of the three-dimensional printer; and
create a command to generate the multiple different bead sizes or ratios at locations within a printing area.

22. The computer system of claim 21, wherein creating a command to generate the multiple different bead sizes or ratios at specific locations within the printing area comprises:
creating a command to change an extrusion rate of material from the three-dimensional printer, wherein the change in extrusion rate conforms to a desired bead size or a location having a particular height where one or more beads are to be deposited.

23. The computer system of claim 21, wherein calculating multiple different bead sizes or ratios for creating the non-planar surface using components of the three-dimensional printer further comprises:
identifying a plurality of parameters that are related to errors that may be caused by a plurality of limitations of the three-dimensional printer, the plurality of limitations including at least one of (1) a minimum bead size that the three-dimensional printer is capable of generating; or (2) a natural lag of an extrusion material that forms beads; and
calculating multiple different bead sizes or ratios based on the plurality of parameters.

24. The computer system of claim 23, wherein calculating multiple different bead sizes or ratios for creating the non-planar surface using components of the three-dimensional printer further comprises computing a difference between a desired extrusion rate and an actual extrusion rate.

25. The computer system of claim 23, wherein calculating multiple different bead sizes or ratios based on the plurality of parameters comprises computing a bead size (1) to diffuse a first error caused by the natural lag of the extrusion material, (2) to diffuse a second error occurring on an adjacent tool path on a same layer, or (3) to diffuse a third error occurring on an adjacent tool path on a different layer.

26. The computer system of claim 23, wherein a first tool path of travel down a slope has a first set of bead sizes, a second tool path of travel up the slope has a second set of bead sizes, and an average size of the first set of bead sizes is greater than that of the second set of bead sizes.

27. The computer system of claim 26, wherein the first tool path and the second tool path are adjacent on the slope, and average effective bead sizes of the first tool path and the second tool path have a finer resolution than a resolution of the three-dimensional printer.

28. The computer system of claim 21, wherein creating a command to generate the multiple different bead sizes at specific locations within the printing area comprises interpolating a particular coordinate within the printing area.

29. The computer system of claim 28, wherein interpolating a particular coordinate within the printing area comprises determining at least one of a bead width, a nozzle height, a travel speed, or an extrusion amount based on the particular shape of the three-dimensional object.

30. The computer system of claim 21, wherein the three-dimensional printer is a thermoset printer.

31. A computer-implemented method for dynamically controlling a three-dimensional printer, the computer-implemented method executed on one more processor, the computer-implemented method comprising:
receiving an indication to cause a three-dimensional printer to print a non-planar surface of a three-dimensional object having a particular shape;
calculating multiple different bead sizes or ratios for creating the non-planar surface; and
creating a command to generate the multiple different bead sizes or ratios at locations within a printing area.

32. The computer-implemented method of claim 31, wherein creating a command to generate the multiple different bead sizes or ratios at specific locations within the printing area comprises:
creating a command to change a extrusion rate of material from the three-dimensional printer, wherein the change in extrusion rate conforms to a desired bead size.

33. The computer-implemented method of claim 32, wherein a higher extrusion rate correlates to a larger bead size.

34. The computer-implemented method of claim 31, wherein creating a command to generate the multiple different bead sizes at specific locations within the printing area comprises:
creating a command to change a speed of a dispenser within the three-dimensional printer, wherein the change in speed conforms to a desired bead size.

35. The computer-implemented method of claim 34, wherein an increase in speed correlates to a smaller bead size.

36. The computer-implemented method of claim 31, further comprising causing the three-dimensional printer to dispense the multiple different bead sizes at specific locations within the printing area.

37. The computer-implemented method of claim 31, wherein calculating multiple different bead sizes or ratios for creating the non-planar surface using three-dimensional components comprises:
determining a length of the non-planar surface;
determine at least one angle of taper associated with the non-planar surface; and
based upon the length of the non-planar surface and the at least one angle of taper, calculating a geometric ratio of bead size differences between adjacent print lines.

38. The computer-implemented method of claim 31, wherein creating a command to generate the multiple different bead sizes at specific locations within the printing area comprises interpolating a particular coordinate within the printing area.

39. The computer-implemented method of claim 38, wherein interpolating a particular coordinate within the printing area includes computing at least one of a bead width, a nozzle height, a travel speed, or an extrusion amount, and creating a command, causing the three-dimensional printer to print based on the computed bead width, nozzle height, travel speed, or extrusion amount.

40. A computer-readable media comprising one or more physical computer-readable storage media having stored thereon computer-executable instructions that, when executed at a processor, cause a computer system to perform a method for dynamically controlling a three-dimensional printer, the method comprising:
receiving an indication to cause a three-dimensional printer to print a non-planar surface of a three-dimensional object having a particular shape;
calculating multiple different bead sizes or ratios for creating the non-planar surface using components of the three-dimensional printer; and
creating a command to generate the multiple different bead sizes or ratios at locations within a printing area.
